(19) United States
(12) Patent Application Publication
(10) Pub. No.: US 2026/0368205 A1
(43) Pub. Date: Nov. 19, 2026

(54) WORK ORDER CATEGORIZATION SYSTEM USING LARGE LANGUAGE MODELS FOR AUTOMATED FAILURE AND MAINTENANCE CODE ASSIGNMENT

(71) Applicant: INTERNATIONAL BUSINESS MACHINES CORPORATION, ARMONK, NY (US)

(72) Inventors: Nianjun Zhou, Chappaqua, NY (US); Dhavalkumar C. Patel, White Plains, NY (US)

(21) Appl. No.: 19/209,670

(22) Filed: May 15, 2025

(51) Int. Cl. G06F 16/28; G06F 16/2457

(52) U.S. Cl. CPC G06F 16/285; G06F 16/24578

(57) ABSTRACT

A computer-implemented method for automated work order categorization and contextual labeling in asset management includes generating an extended work order description using a large language model (LLM), the extended work order description including additional descriptive information. The additional descriptive information provides context comprehension for semantic matching. The extended work order description is matched with predefined failure or maintenance codes. The failure or maintenance codes are dynamically updated and refined based on new work order patterns.

### BACKGROUND

The present disclosure generally relates to systems and methods for work order categorization.

A work order (WO) is a record used to track and manage maintenance tasks for equipment or assets. A work order includes important details to help efficiently organize, prioritize, and complete maintenance work. A WO can include (a) asset information, such as asset identification, location, and site; (b) work details, such as a work description (task explanation) and work type (e.g., emergency, preventive, predictive); (c) priorities, such as work priority (urgency of the task), and asset priority (importance of the equipment; (d) scheduling, including reported date, target start/finish, actual finish, duration, and actual labor hours; (d) work status, including the status of the task (e.g., pending, ready to start, or completed); and (e) linked data that can connect to asset details for consistency (e.g., location, priority, and attributes).

### SUMMARY

In one embodiment, a system and method are described for automated work order categorization and contextual labeling in asset management.

In one embodiment, a computer implemented method, and a computer program product having program instructions executable for performing the method, can be configured for automated work order categorization and contextual labeling in asset management. The method can include generating an extended work order description using a large language model (LLM), the extended work order description including additional descriptive information. The extended work order description is matched with predefined failure or maintenance codes. The failure or maintenance codes are dynamically updated and refined based on new work order patterns. The additional descriptive information can provide context comprehension for semantic matching.

In another embodiment, a system includes a processor; a data bus coupled to the processor; a memory coupled to the data bus; and a computer-usable medium embodying a computer program code, the computer program code comprising instructions executable by the processor. The computer program code is configured to generate an extended work order description using a large language model (LLM), the extended work order description including additional descriptive information. The extended work order description is matched with predefined failure or maintenance codes. The failure or maintenance codes are dynamically updated and refined based on new work order patterns. The additional descriptive information can provide context comprehension for semantic matching.

These and other features will become apparent from the following detailed description of illustrative embodiments thereof, which is to be read in connection with the accompanying drawings.

### BRIEF DESCRIPTION OF THE DRAWINGS

The drawings are of illustrative embodiments. They do not illustrate all embodiments. Other embodiments may be used in addition or instead. Details that may be apparent or unnecessary may be omitted to save space or for more effective illustration. Some embodiments may be practiced with additional components or steps and/or without all the components or steps that are illustrated. When the same numeral appears in different drawings, it refers to the same or like components or steps.

FIG. 1 shows a schematic representation of a workflow that connects assets to failure modes and job plans that allows for effective asset management, consistent with an illustrative embodiment;

FIG. 2 shows an example of an original corrective work order, in an unstructured format;

FIG. 3 shows an example of label association with the work order of FIG. 2, consistent with an illustrative embodiment;

FIG. 4 shows a high-level view of a work order categorization process, consistent with an illustrative embodiment;

FIG. 5 shows a system architecture diagram of a work order categorization system using large language models for automated failure and maintenance label (code) assignment, consistent with an illustrative embodiment;

FIG. 6 shows a detailed view of the work order expansion process, consistent with an illustrative embodiment;

FIG. 7 shows an algorithm for semantic sentence comparison for failure code labeling, consistent with an illustrative embodiment;

FIG. 8 shows an example of how a system and method for work order categorization can assign or associate labels or failure codes, consistent with an illustrative embodiment;

FIG. 9 shows how the pool of labels can be refined and enriched for a specific dataset, consistent with an illustrative embodiment;

FIG. 10A shows a diagram illustrating a label/categorization process, consistent with an illustrative embodiment;

FIG. 10B shows a diagram illustrating a label/categorization process, consistent with an illustrative embodiment; and

FIG. 11 is a functional block diagram illustration of a computer hardware platform that can be used to implement the method for work order categorization, consistent with an illustrative embodiment.

### DETAILED DESCRIPTION

As described in greater detail below, aspects of the present disclosure provide a work order categorization system using large language models (LLM models) for work order labeling with automated failure and maintenance-code- assignment. The LLM models may be trained using large datasets, where such models provide work order labeling that could not be performed in the human mind.

The system allows organizations to manage a vast number of assets and associated failure modes. Each failure code is associated with a failure category, primary failure, and secondary failure codes with their descriptions. The total number of assets and failure modes depends on the specific asset type, operation environment, and the organization's requirements.

Users can create and manage asset records for various equipment and machinery used within an enterprise. These assets can be categorized and detailed with information such as location, vendor, status, and maintenance costs. The system supports both rotating and non-rotating assets, facilitating detailed tracking and management.

In terms of failure modes, the system provides a structured approach to failure reporting and analysis. Users can build failure hierarchies that include failure classes, problems, causes, and remedies. This hierarchical structure aids in recording, reporting, and analyzing asset and location failures over time. New failure or maintenance codes can be built into a hierarchical structure of existing codes. The hierarchical structure for labels can be dynamically updated based on contextual information extracted from the extended work order description.

Currently, many work orders are created manually, often relying on context known only to the creator or solely for the purpose of initiating a work order. This lack of standardization with the failure or maintenance codes hinders effective analysis and automation. Aspects of the present disclosure provide systems and methods to enable standardized work orders to facilitate advanced analysis for the enterprise, including bundling, predicting the next work order, and associating alerts and anomalies with work order recommendations.

Although the operational/functional descriptions described herein may be understandable by the human mind, they are not abstract ideas of the operations/functions divorced from computational implementation of those operations/functions. Rather, the operations/functions represent a specification for an appropriately configured computing device. For example, the large language models (LLMs) may be trained using large amounts of data that cannot be processed through the human mind. As discussed in detail below, the operational/functional language is to be read in its proper technological context, i.e., as concrete specifications for physical implementations.

Accordingly, one or more of the embodiments discussed herein may provide a work order categorization system using large language models (LLMs) for automated failure and maintenance label (code) assignment. This may have the technical effect of enabling standardized work orders to facilitate advanced analysis, including bundling, predicting the next work order, and associating alerts and anomalies with work order generation. Accordingly, the system and methods according to aspects of the present disclosure provide a substantial improvement to technology and computer functionality.

It should be appreciated that aspects of the teachings herein are beyond the capability of a human mind. It should also be appreciated that the various embodiments of the subject disclosure described herein can include information that is impossible to obtain manually by an entity, such as a human user. For example, the type, amount, and/or variety of information included in performing the process discussed herein can be more complex than information that could be reasonably be processed manually by a human user.

As used herein, the “categorization” of a work order is called a “label”. The process of generating this categorization is called labeling. The meaning of a label is a failure or management code assignment. Each assignment or labeling contains a failure category, primary and secondary codes, and corresponding descriptions. In the present disclosure, the term label or failure code are exchangeable in this context. The label, as described herein, can itself have a hierarchy.

A work order (WO) is a record used to track and manage maintenance tasks for equipment or assets. It includes important details to help efficiently organize, prioritize, and complete maintenance work.

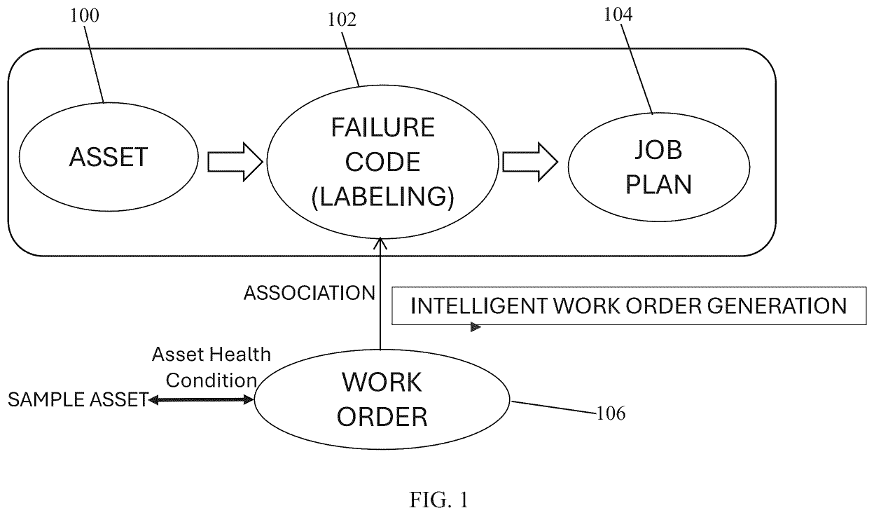

Referring to FIG. 1, an asset 100 can be associated with a failure code 102. Through analysis of the failure code 102 and the asset 100, a job plan 104 can be identified. A work order 106 can be associated with the failure code 102. Intelligent work order generation is enabled with this association, providing features such as work order prediction, causality analysis, work order recommendation from an alert, anomaly, and historical events.

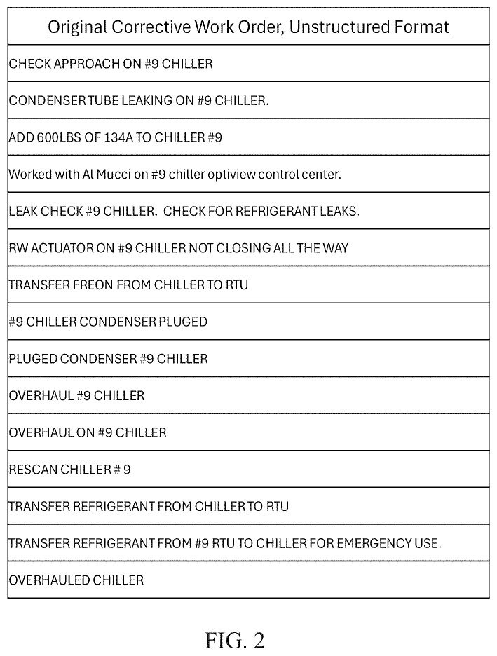

FIG. 2 shows an example of the descriptions of a list of historical work order in an unstructured format. Such a description is typically in handwritten, free-text format by technicians, often with inconsistent and incomplete entries. Further, such unstructured work orders use unclear jargon or abbreviations that may be known to the technician, but may be unknown by a non-technical person or even another technician. Such unstructured work orders are ad-hoc and variable in quality. Without a proper labeling assignment, such work orders cannot be utilized for more advanced analysis, including planning and prediction.

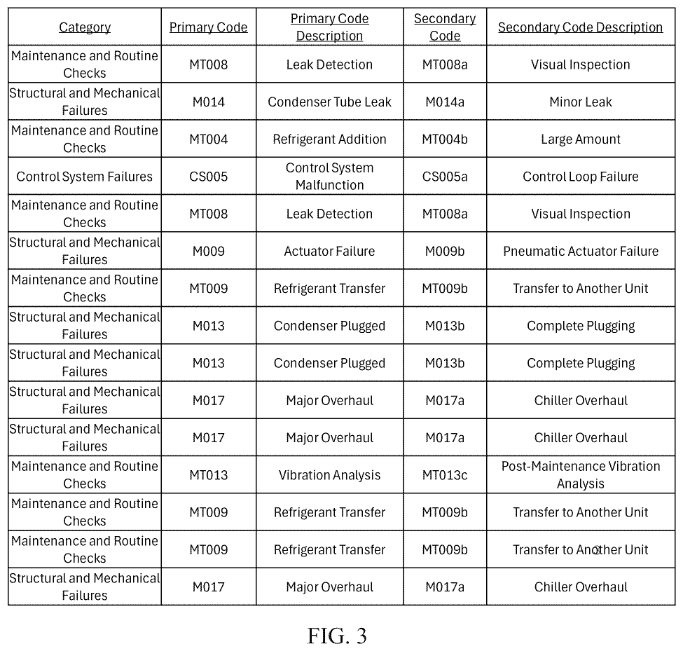

As described in greater detail below, aspects of the present disclosure can provide structures work order categorization, as illustrated in FIG. 3. Such standardized work orders facilitate advanced analysis, including bundling, predicting the next work order, and associating alerts and anomalies with work order generation.

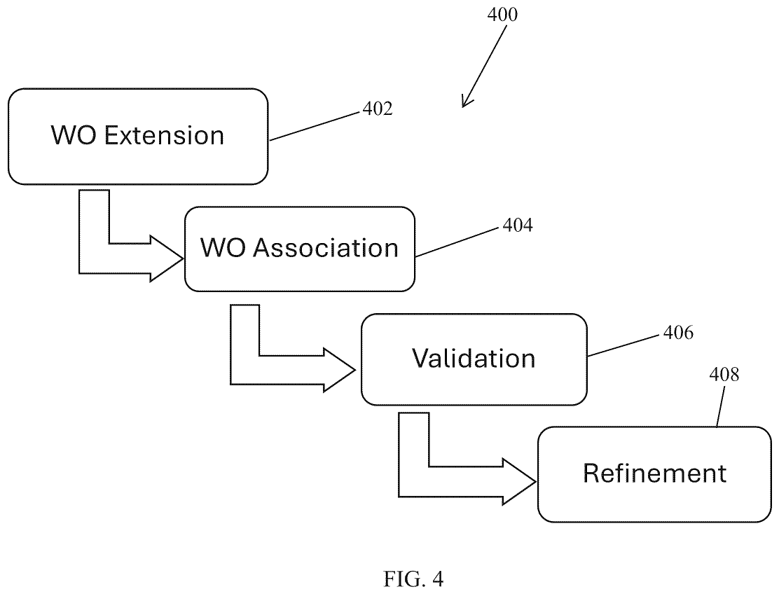

The work order categorization process 400 is summarized in FIG. 4. Additional details for each step are provided below. At block 402, the work order description is extended with the help of LLM with domain-specific prompts to fix the low quality of the original text description and to contain more context aligned with the asset to which the work order is drawn. Such expansion creates a base for having proper labeling assignment. At block 404, the extended work order description is associated with the failure code. The association is quantified with the semantic similarity score, as described below, with the ranking.

At block 406, additional validation is performed for the recommendation from the prior work order association. A recommendation is selected from the large language model (LLM) judge. The LLM judge may serve as a reflective evaluator in making the recommendation to ensure a most suitable candidate is selected with enhanced accuracy from the plurality of candidate codes (the labels). At block 408, if there is no reliable association identified, this is an indicator for updating the labels.

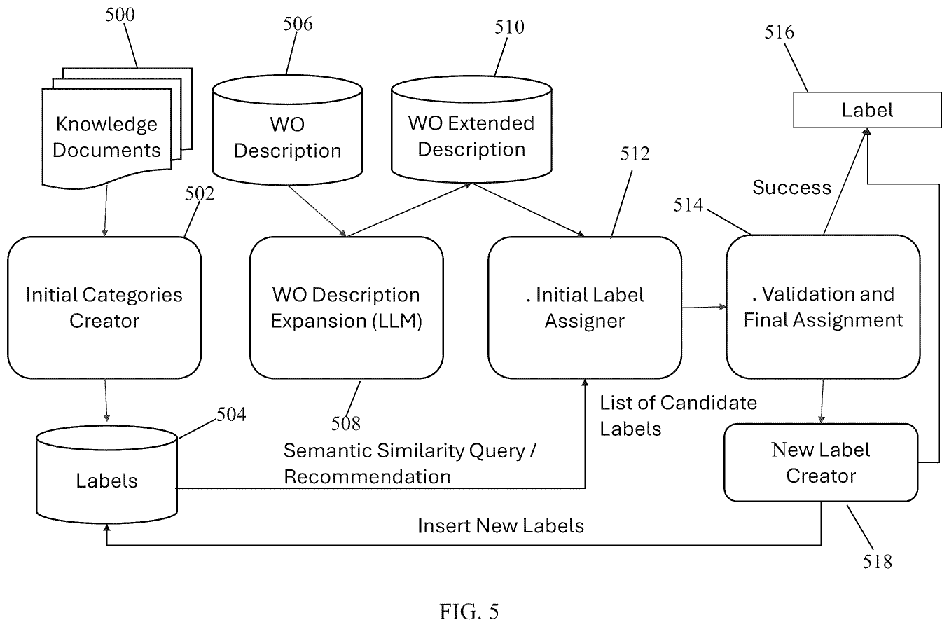

Referring to FIG. 5, knowledge documents 500 can be used in an initial category creator 502 to develop a labels database 504. Initially, the labels database 504 is considered, at this stage, to include an initial set of labels that may be further expanded upon, as described below.

Work order descriptions 506, such as the unstructured work order terms of FIG. 2, may be fed to a work order description expansion block 508. The work order description expansion block 508 can rely on a large language model for associating standardized work order terms with the work order descriptions 506, resulting in the categories of FIG. 3, to create the work order extended descriptions 510.

Some examples illustrating the original work order language and the work order extended descriptions are as follows: (a) “PM chiller” may be extended to “This work order likely indicates the need for routine preventive maintenance on the chiller. The failure mode is a lack of regular maintenance, which can lead to a variety of issues, including reduced efficiency, poor performance, and even system failure.”; (b) “Transfer refrigerant back to chiller” may be extended to “This work order indicates the need to transfer refrigerant back to the chiller from another unit. The failure mode could involve issues such as: 1) Refrigerant Leak: There might be a leak in the other unit, necessitating the transfer of refrigerant back to the chiller. 2) Refrigerant Imbalance: Improper refrigerant levels can affect the efficiency and performance of both the chiller and the other unit.”; (c) “Chiller 12 cleaning” may be extended to “This work order likely indicates the need to clean the chiller due to a buildup of dirt, debris, or other contaminants. This can lead to reduced efficiency, poor performance, and even system failure if not addressed.”; (d) “Clean chiller” may be extended to “This work order likely indicates the need to clean the chiller due to a buildup of dirt, debris, or other contaminants. This can lead to reduced efficiency, poor performance, and even system failure if not addressed.”; and (e) “Fill chiller” may be extended to “This work order likely indicates that the chiller's refrigerant level is low and needs to be refilled. This can lead to reduced efficiency, poor performance, and even system failure if not addressed.” The additional context provided by the work order extended descriptions can provide for context comprehension for semantic matching. As can be seen, the work order extended descriptions may use standardized formats and terms to provide better comparisons and semantic matching via the large language models in selecting a candidate of labels, such as a candidate code or multiple candidate codes, and determining a similarity score therewith.

The initial label assigner 512 can receive a list of candidate labels from the labels database 504 based on a semantic similarity query of comparing the semantic similarity over the description of the label (concatenated from the failure code category, primary and secondary description). The similarity query is accomplished using a NLP language model specialized in similarity analysis. At the validation and final assignment block 514, it is determined whether a label from the list of candidate labels, as described below, is a match for the work order category from the work order extended descriptions 510. If there is a match, then the label is assigned at block 516. If there is no match, a new label creator 518 can create a new label, assign the new label at block 516, and insert the new label into the new labels database 504.

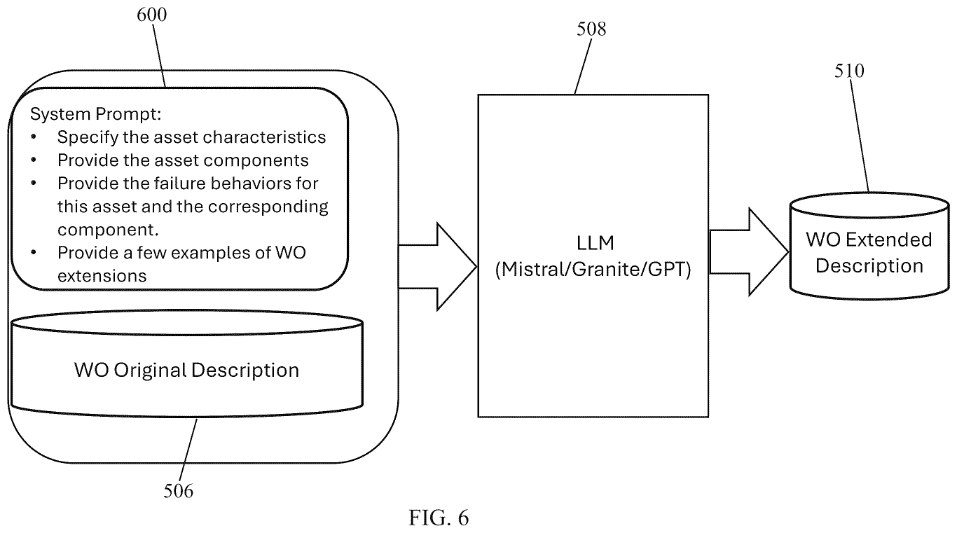

FIG. 6 shows a process for obtaining the work order extended descriptions 510. The work order description 506 (that is, the work order original description as provided, for example, by a technician, as described above) can be used in conjunction with a domain specific, hand-drafted system prompts 600. Such system prompts 600 can include, as non-limiting examples, specify the asset characteristics, provide the asset components, provide the failure behaviors for this asset and the corresponding component, provide a few examples of work order extensions, and the like. The answers to the system prompts 600 and the work order description 506 can be fed to the large language model (LLM) 602 to output the work order extended description 510.

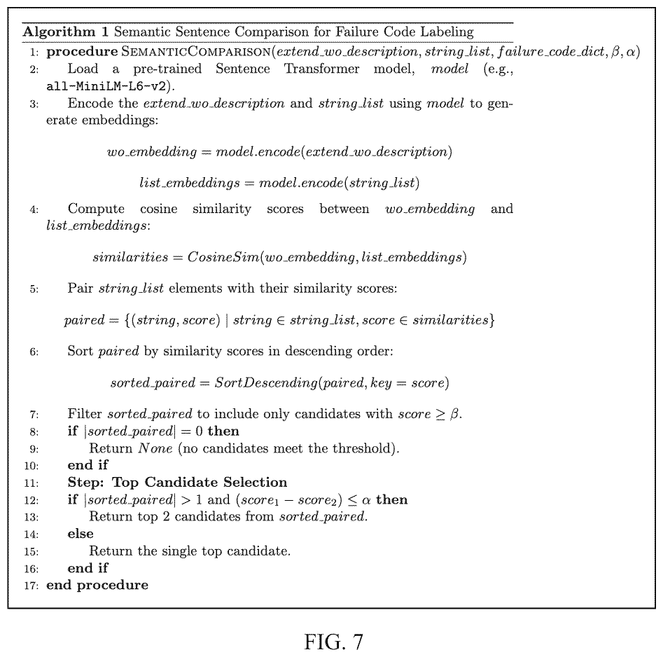

FIG. 7 shows an algorithm that may be used by the initial label assigner 512 (see FIG. 5), where the work order extended description 510 is used, in conjunction with the labels database 504. A semantic similarity query may be performed to generate a list of candidate labels and provide a similarity score for those candidate labels.

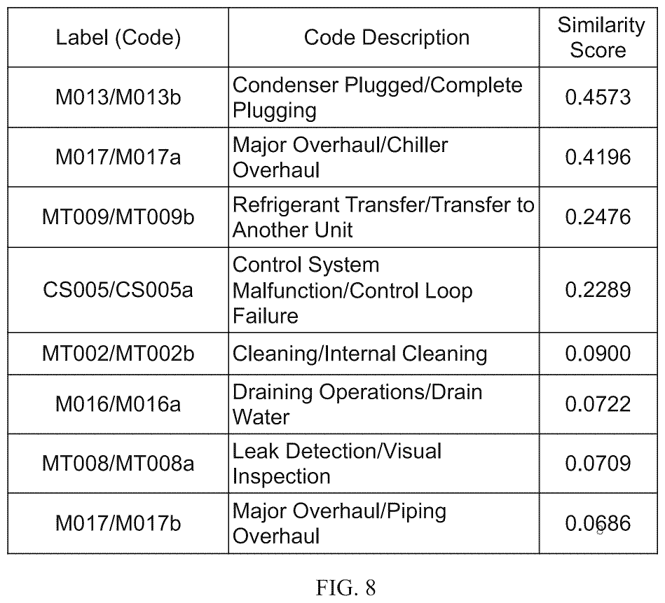

FIG. 8 shows an example of a list of candidate labels and their calculated similarity score. In this example, the work order may have stated, “Condenser plugged on #9 chiller”. Via the methods described above, a work order extended description may be formed, stating, “When a condenser in a chiller becomes plugged, it can lead to several operational issues, including reduced heat transfer efficiency, increased pressure in the system, and potential overheating. This can ultimately cause the chiller to perform poorly or fail entirely if not addressed promptly. The blockage could be due to debris, scale buildup, or other contaminants in the condenser tubes. Regular maintenance and cleaning are necessary to prevent such issues.” This extended description may be used to generate the list of candidate labels of FIG. 8. The algorithm of FIG. 7 can calculate the similarity scores and a predetermined threshold may be set for the similarity score, such that only those above this predetermined threshold are chosen as labels for the work order. In the example of FIG. 8, the top two work orders may be the selected labels. The algorithm may limit the number of work orders to two, for example.

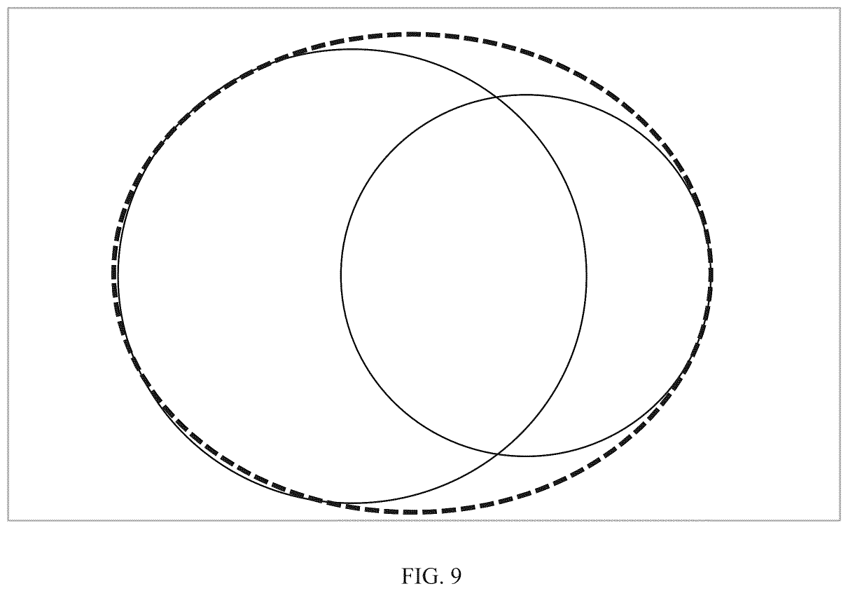

As discussed above, typically the system can assign the top label with the closest match. Usually, this process does not involve LLM judging and creating a new label. However, as shown in FIG. 9, within a pool of work orders 900, there exists a pool of labels 902. In some situations, the label assignment 904 may be outside of the current pool of labels 902. In these situations, the pool of labels 902 can be enriched by the labels that are within the label assignment 904, but outside the current pool of labels 902. The new label creator 518 can be used to create new labels (such as the new failure and maintenance codes) and add the new labels to the labels database 504 (see FIG. 5).

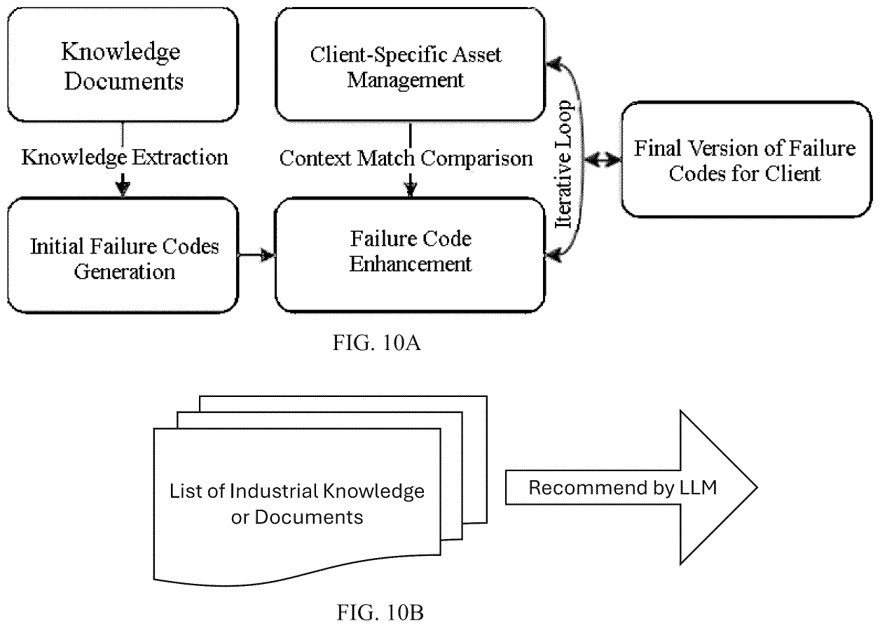

Referring to FIGS. 10A and 10B, a label/categorization creation process is illustrated. Knowledge extraction from knowledge documents 1000 can result in initial failure code generation 1002. Based on client-specific asset management information 1004, a context match comparison can be performed to provide failure code enhancement 1006. The failure code enhancement 1006 may be carried out in an iterative loop with the client-specific asset management information 1004 to result in a final version of failure codes for a client 1008. Further, from industrial knowledge or documents 1010, the large language model can further recommend labels. The labels can be provided in a hierarchical arrangement, with a limited number of primary labels and, optionally, one or more secondary labels for the associated primary label.

Typically, the top hierarchy will remain unchanged, comprising, in one example, nine categories of failure or maintenance based on the nature of the work orders. The primary code will remain stable, with only the secondary code requiring occasional additions. If a work order categorization fails (usually, it is not possible to find a proper secondary failure code), a new code or label will be initiated and assigned. Newly generated labels are added to a shared pool, addressing unprocessed cases to minimize the proliferation of failure codes/labels. Interactive refinement can occur by continuously looping through unprocessed work orders and assigning new labels, where applicable, based on acceptable semantic similarity scores.

After labeling historical work orders, the system can continuously update its categorizations by learning from new data patterns containing new types of work orders to maintain accuracy and relevance in evolving operational contexts. In a deployment mode the system can analyze and semantically match them with predefined failure or maintenance codes, such as those shown in FIG. 3. The system can dynamically categorize the categorizations for rapid and accurate processing. Dynamic refinement can occur when the system selects a candidate category or label for low-confidence cases or new scenarios and suggests additional label options for potential review. A failure or maintenance code can be flagged for automatic feedback to enable continuous improvement through learning from adjustment. Dynamic refinement can incorporate operator feedback to refine categorizations and update the label pool during operation.

Aspects of the present disclosure can provide significant improvements in various areas as compared to conventional approaches. For example, in the core methodology, small and medium enterprises (SMEs) manually create and refine codes, while the present disclosure uses LLMs and artificial intelligence (AI), and semantic matching. With respect to contextual understanding, conventional methods rely on SME expertise for interpretation, while the present disclosure uses AI to extend the work order descriptions for context. For label development, the present disclosure can dynamically generate and refine labels to accommodate the evolving of the asset repair and maintenance practice. For categorization, the present disclosure can perform this in an automated manner, with similarity scoring. For validation, the present disclosure can use an LLM judge to ensure accuracy dynamically. For adaptability, the present disclosure can automatically update labels based on new patterns. Of course, other benefits may be appreciated based on the above disclosure.

### Example Computing Platform

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

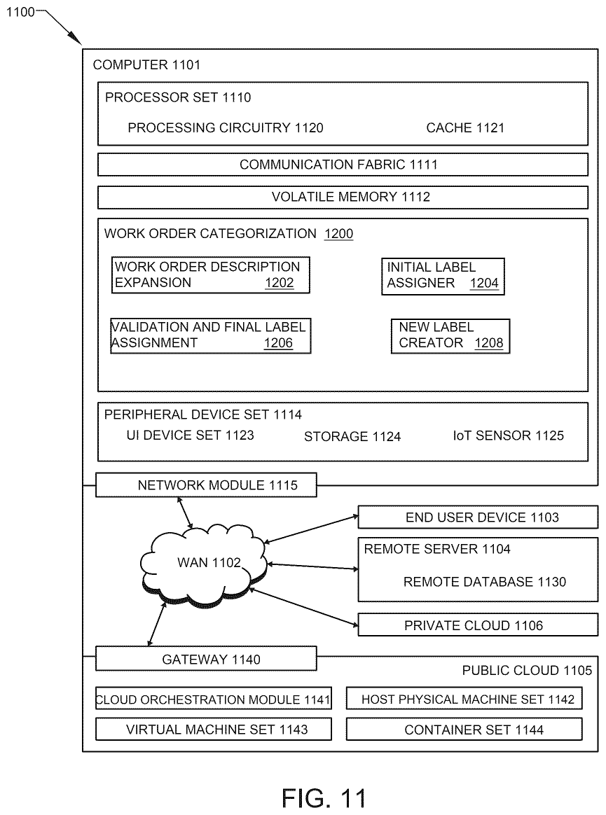

Referring to FIG. 11, computing environment 1100 includes an example of an environment for the execution of at least some of the computer code involved in performing the inventive methods, including a work order categorization block 1200, which can include a work order description expansion block 1202, an initial label assigner block 1204, a validation and final label assignment block 1206, and a new label creator block 1208. In addition to block 1200, computing environment 1100 includes, for example, computer 1101, wide area network (WAN) 1102, end user device (EUD) 1103, remote server 1104, public cloud 1105, and private cloud 1106. In this embodiment, computer 1101 includes processor set 1110 (including processing circuitry 1120 and cache 1121), communication fabric 1111, volatile memory 1112, persistent storage 1113 (including operating system 1122 and block 1200, as identified above), peripheral device set 1114 (including user interface (UI) device set 1123, storage 1124, and Internet of Things (IoT) sensor set 1125), and network module 1115. Remote server 1104 includes remote database 1130. Public cloud 1105 includes gateway 1140, cloud orchestration module 1141, host physical machine set 1142, virtual machine set 1143, and container set 1144.

COMPUTER 1101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 1130. As is well understood in the art of computer technology, and depending upon the technology, performance of a computer-implemented method may be distributed among multiple computers and/or between multiple locations. On the other hand, in this presentation of computing environment 1100, detailed discussion is focused on a single computer, specifically computer 1101, to keep the presentation as simple as possible. Computer 1101 may be located in a cloud, even though it is not shown in a cloud in FIG. 11. On the other hand, computer 1101 is not required to be in a cloud except to any extent as may be affirmatively indicated.

PROCESSOR SET 1110 includes one, or more, computer processors of any type now known or to be developed in the future. Processing circuitry 1120 may be distributed over multiple packages, for example, multiple, coordinated integrated circuit chips. Processing circuitry 1120 may implement multiple processor threads and/or multiple processor cores. Cache 1121 is memory that is located in the processor chip package(s) and is typically used for data or code that should be available for rapid access by the threads or cores running on processor set 1110. Cache memories are typically organized into multiple levels depending upon relative proximity to the processing circuitry. Alternatively, some, or all, of the cache for the processor set may be located “off chip.” In some computing environments, processor set 1110 may be designed for working with qubits and performing quantum computing.

Computer readable program instructions are typically loaded onto computer 1101 to cause a series of operational steps to be performed by processor set 1110 of computer 1101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 1121 and the other storage media discussed below. The program instructions, and associated data, are accessed by processor set 1110 to control and direct performance of the inventive methods. In computing environment 1100, at least some of the instructions for performing the inventive methods may be stored in block 1200 in persistent storage 1113.

COMMUNICATION FABRIC 1111 is the signal conduction path that allows the various components of computer 1101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 1112 is any type of volatile memory now known or to be developed in the future. Examples include dynamic type random access memory (RAM) or static type RAM. Typically, volatile memory 1112 is characterized by random access, but this is not required unless affirmatively indicated. In computer 1101, the volatile memory 1112 is located in a single package and is internal to computer 1101, but, alternatively or additionally, the volatile memory may be distributed over multiple packages and/or located externally with respect to computer 1101.

PERSISTENT STORAGE 1113 is any form of non-volatile storage for computers that is now known or to be developed in the future. The non-volatility of this storage means that the stored data is maintained regardless of whether power is being supplied to computer 1101 and/or directly to persistent storage 1113. Persistent storage 1113 may be a read only memory (ROM), but typically at least a portion of the persistent storage allows writing of data, deletion of data and re-writing of data. Some familiar forms of persistent storage include magnetic disks and solid state storage devices. Operating system 1122 may take several forms, such as various known proprietary operating systems or open source Portable Operating System Interface-type operating systems that employ a kernel. The code included in block 1200 typically includes at least some of the computer code involved in performing the inventive methods.

PERIPHERAL DEVICE SET 1114 includes the set of peripheral devices of computer 1101. Data communication connections between the peripheral devices and the other components of computer 1101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 1123 may include components such as a display screen, speaker, microphone, wearable devices (such as goggles and smart watches), keyboard, mouse, printer, touchpad, game controllers, and haptic devices. Storage 1124 is external storage, such as an external hard drive, or insertable storage, such as an SD card. Storage 1124 may be persistent and/or volatile. In some embodiments, storage 1124 may take the form of a quantum computing storage device for storing data in the form of qubits. In embodiments where computer 1101 is required to have a large amount of storage (for example, where computer 1101 locally stores and manages a large database) then this storage may be provided by peripheral storage devices designed for storing very large amounts of data, such as a storage area network (SAN) that is shared by multiple, geographically distributed computers. IoT sensor set 1125 is made up of sensors that can be used in Internet of Things applications. For example, one sensor may be a thermometer and another sensor may be a motion detector.

NETWORK MODULE 1115 is the collection of computer software, hardware, and firmware that allows computer 1101 to communicate with other computers through WAN 1102. Network module 1115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 1115 are performed on the same physical hardware device. In other embodiments (for example, embodiments that utilize software-defined networking (SDN)), the control functions and the forwarding functions of network module 1115 are performed on physically separate devices, such that the control functions manage several different network hardware devices. Computer readable program instructions for performing the inventive methods can typically be downloaded to computer 1101 from an external computer or external storage device through a network adapter card or network interface included in network module 1115.

WAN 1102 is any wide area network (for example, the internet) capable of communicating computer data over non-local distances by any technology for communicating computer data, now known or to be developed in the future. In some embodiments, the WAN 1102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 1103 is any computer system that is used and controlled by an end user (for example, a customer of an enterprise that operates computer 1101), and may take any of the forms discussed above in connection with computer 1101. EUD 1103 typically receives helpful and useful data from the operations of computer 1101. For example, in a hypothetical case where computer 1101 is designed to provide a recommendation to an end user, this recommendation would typically be communicated from network module 1115 of computer 1101 through WAN 1102 to EUD 1103. In this way, EUD 1103 can display, or otherwise present, the recommendation to an end user. In some embodiments, EUD 1103 may be a client device, such as thin client, heavy client, mainframe computer, desktop computer and so on.

REMOTE SERVER 1104 is any computer system that serves at least some data and/or functionality to computer 1101. Remote server 1104 may be controlled and used by the same entity that operates computer 1101. Remote server 1104 represents the machine(s) that collect and store helpful and useful data for use by other computers, such as computer 1101. For example, in a hypothetical case where computer 1101 is designed and programmed to provide a recommendation based on historical data, then this historical data may be provided to computer 1101 from remote database 1130 of remote server 1104.

PUBLIC CLOUD 1105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 1105 is performed by the computer hardware and/or software of cloud orchestration module 1141. The computing resources provided by public cloud 1105 are typically implemented by virtual computing environments that run on various computers making up the computers of host physical machine set 1142, which is the universe of physical computers in and/or available to public cloud 1105. The virtual computing environments (VCEs) typically take the form of virtual machines from virtual machine set 1143 and/or containers from container set 1144. It is understood that these VCEs may be stored as images and may be transferred among and between the various physical machine hosts, either as images or after instantiation of the VCE. Cloud orchestration module 1141 manages the transfer and storage of images, deploys new instantiations of VCEs and manages active instantiations of VCE deployments. Gateway 1140 is the collection of computer software, hardware, and firmware that allows public cloud 1105 to communicate through WAN 1102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 1106 is similar to public cloud 1105, except that the computing resources are only available for use by a single enterprise. While private cloud 1106 is depicted as being in communication with WAN 1102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 1105 and private cloud 1106 are both part of a larger hybrid cloud.

### Conclusion

The descriptions of the various embodiments of the present teachings have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

While the foregoing has described what are considered to be the best state and/or other examples, it is understood that various modifications may be made therein and that the subject matter disclosed herein may be implemented in various forms and examples, and that the teachings may be applied in numerous applications, only some of which have been described herein. It is intended by the following claims to claim any and all applications, modifications, and variations that fall within the true scope of the present teachings.

The components, steps, features, objects, benefits, and advantages that have been discussed herein are merely illustrative. None of them, nor the discussions relating to them, are intended to limit the scope of protection. While various advantages have been discussed herein, it will be understood that not all embodiments necessarily include all advantages. Unless otherwise stated, all measurements, values, ratings, positions, magnitudes, sizes, and other specifications that are set forth in this specification, including in the claims that follow, are approximate, not exact. They are intended to have a reasonable range that is consistent with the functions to which they relate and with what is customary in the art to which they pertain.

Numerous other embodiments are also contemplated. These include embodiments that have fewer, additional, and/or different components, steps, features, objects, benefits and advantages. These also include embodiments in which the components and/or steps are arranged and/or ordered differently.

Aspects of the present disclosure are described herein with reference to a flowchart illustration and/or block diagram of a method, apparatus (systems), and computer program products according to embodiments of the present disclosure. It will be understood that each block of the flowchart illustrations and/or block diagrams, and combinations of blocks in the flowchart illustrations and/or block diagrams, can be implemented by computer readable program instructions.

These computer readable program instructions may be provided to a processor of an appropriately configured computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The call-flow, flowchart, and block diagrams in the figures herein illustrate the architecture, functionality, and operation of possible implementations of systems, methods, and computer program products according to various embodiments of the present disclosure. In this regard, each block in the flowchart or block diagrams may represent a module, segment, or portion of instructions, which comprises one or more executable instructions for implementing the specified logical function(s). In some alternative implementations, the functions noted in the blocks may occur out of order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

While the foregoing has been described in conjunction with exemplary embodiments, it is understood that the term “exemplary” is merely meant as an example, rather than the best or optimal. Except as stated immediately above, nothing that has been stated or illustrated is intended or should be interpreted to cause a dedication of any component, step, feature, object, benefit, advantage, or equivalent to the public, regardless of whether it is or is not recited in the claims.

It will be understood that the terms and expressions used herein have the ordinary meaning as is accorded to such terms and expressions with respect to their corresponding respective areas of inquiry and study except where specific meanings have otherwise been set forth herein. Relational terms such as first and second and the like may be used solely to distinguish one entity or action from another without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “a” or “an” does not, without further constraints, preclude the existence of additional identical elements in the process, method, article, or apparatus that comprises the element.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments have more features than are expressly recited in each claim. Rather, as the following claims reflect, the inventive subject matter lies in less than all features of a single disclosed embodiment. Thus, the following claims are hereby incorporated into the Detailed Description, with each claim standing on its own as a separately claimed subject matter.

1. A computer-implemented method for automated work order categorization and contextual labeling in asset management, comprising:
generating an extended work order description using a large language model (LLM), the extended work order description including additional descriptive information;
matching the extended work order description with predefined failure or maintenance codes; and
dynamically updating and refining the predefined failure or maintenance codes based on new work order patterns, thereby enabling standardized work orders to facilitate advanced analysis, including bundling, predicting a next work order, and associating alerts and anomalies with work order generation.

2. The computer-implemented method of claim 1, wherein the additional descriptive information provides context comprehension for semantic matching.

3. The computer-implemented method of claim 1, further comprising generating a similarity score between the extended work order description and each of the predefined failure or maintenance codes.

4. The computer-implemented method of claim 3, further comprising selecting a candidate code based on the similarity score exceeding a predetermined threshold.

5. The computer-implemented method of claim 4, further comprising selecting a plurality of candidate codes based on the similarity score of each of the plurality of candidate codes exceeding the predetermined threshold of the similarity score.

6. The computer-implemented method of claim 5, further comprising using the LLM as a judge to ensure a most suitable candidate is selected with enhanced accuracy from the plurality of candidate codes.

7. The computer-implemented method of claim 4, further comprising creating a new failure or maintenance code when no candidate code exceeds the predetermined threshold of the similarity score.

8. The computer-implemented method of claim 7, further comprising incorporating the new failure or maintenance code into a hierarchical structure of existing codes.

9. The computer-implemented method of claim 7, further comprising flagging the new failure or maintenance code for automatic feedback to enable continuous improvement through learning from adjustment.

10. The computer-implemented method of claim 1, further comprising dynamically updating a hierarchical structure for labels based on contextual information extracted from the extended work order description.

11. A system comprising:
a processor;
a data bus coupled to the processor;
a memory coupled to the data bus; and
a computer-usable medium embodying a computer program code, the computer program code comprising instructions executable by the processor and configured to:
generate an extended work order description using a large language model (LLM), the extended work order description including additional descriptive information;
match the extended work order description with predefined failure or maintenance codes; and
dynamically update and refine the predefined failure or maintenance codes based on new work order patterns,
wherein the additional descriptive information provides context comprehension for semantic matching.

12. The system of claim 11, wherein the instructions are further configured to:
generate a similarity score between the extended work order description and each of the predefined failure or maintenance codes; and
select a candidate code based on the similarity score exceeding a predetermined threshold.

13. The system of claim 12, wherein the instructions are further configured to:
select a plurality of candidate codes based on the similarity score of each of the plurality of candidate codes exceeding the predetermined threshold; and
use the LLM as a judge to ensure a most suitable candidate is selected with enhanced accuracy from the plurality of candidate codes.

14. The system of claim 12, wherein the instructions are further configured to create a new failure or maintenance code when no candidate code exceeds the predetermined threshold of the similarity score.

15. The system of claim 14, wherein the instructions are further configured to incorporate the new failure or maintenance code into a hierarchical structure of existing codes.

16. A computer program product for automated work order categorization and contextual labeling in asset management, the computer program product comprising a computer readable storage medium having program instructions embodied therewith, the program instructions executable by a computer to cause the computer to:
generate an extended work order description using a large language model (LLM), the extended work order description including additional descriptive information;
match the extended work order description with predefined failure or maintenance codes; and
dynamically update and refine the predefined failure or maintenance codes based on new work order patterns,
wherein the additional descriptive information provides context comprehension for semantic matching.

17. The computer program product of claim 16, wherein the instructions are further configured to:
generate a similarity score between the extended work order description and each of the predefined failure or maintenance codes; and
select a candidate code based on the similarity score exceeding a predetermined threshold.

18. The computer program product of claim 17, wherein the instructions are further configured to:
select a plurality of candidate codes based on the similarity score of each of the plurality of candidate codes exceeding the predetermined threshold; and
use the LLM as a judge to ensure a most suitable candidate is selected with enhanced accuracy from the plurality of candidate codes.

19. The computer program product of claim 17, wherein the instructions are further configured to create a new failure or maintenance code when no candidate code exceeds the predetermined threshold.

20. The computer program product of claim 19, wherein the instructions are further configured to incorporate the new failure or maintenance code into a hierarchical structure of existing codes.
